(19) United States
(12) Patent Application Publication
(10) Pub. No.: US 2008/0076680 A1
(43) Pub. Date: Mar. 27, 2008

(54) System and apparatus for automated protein analysis priority

(75) Inventor: Bakshy Akshaykirti Chibber, Mishawaka, IN (US)

Correspondence Address: ICE MILLER LLP, ONE AMERICAN SQUARE, SUITE 3100, INDIANAPOLIS, IN, 46282-0200, US

(73) Assignee: Ozone Research Frontier Ltd., Indianapolis, IN (US)

(21) Appl. No.: 11/786,498

(22) Filed: Apr. 12, 2007

Related U.S. Application Data
(60) Provisional application No. 60/744,760, filed on Apr. 13, 2006.
(60) Provisional application No. 60/807,344, filed on Jul. 14, 2006.
(60) Provisional application No. 60/863,570, filed on Oct. 30, 2006.

(51) Int. Cl. C40B 60/10

(52) U.S. Cl. 506/38

(57) ABSTRACT

The present application relates to a system and apparatus for protein sequencing that incorporates a modular system that allows for high throughput and flexibility in the use of a detection system to provide a more robust sequencing system. In one embodiment, a sample plate containing multiple sample wells may be loaded into the apparatus and processed simultaneously using an automated chemical degradation, digestion, or ladder process resulting in multiple products that can be produced without regard to the reduction in throughput associated with conversion of eluted products.

### PRIORITY

The present nonprovisional application claims priority to U.S. Provisional Patent Application Ser. No. 60/744,760, filed Apr. 13, 2006, and titled AUTOMATED CHEMICAL ANALYZER, Provisional Patent Application Ser. No. 60/807344, filed Jul. 14, 2006, and titled AN AUTOMATED REACTOR DEVICE, and U.S. Provisional Patent Application Ser. No. 60/863,570 and titled EFFICIENT METHOD FOR PARTIAL SEQUENCING OF PEPTIDE/PROTEIN USING ACID OR BASE XANTHATES, filed Oct. 30, 2006.

### BACKGROUND

The present application relates to the field of protein sequencing. In particular, the present application relates to a system and apparatus for protein sequencing allowing high throughput of samples with high sensitivity.

Protein sequencing is used in many biochemical, pharmaceutical, and biomedical research fields to determine the amino acid composition of a sample protein, as well as the sequence in which those amino acids take within a given protein. By determining the amino acid sequence of a new protein, its structural conformation can be better known. Further, an unknown sample protein can be readily identified as a previously known protein through the use of protein sequencing.

Protein sequencing can be performed in a number of different manners, from the use of the Edman degradation reaction, thioacylation, or the use of mass spectrometry, matrix assisted laser desorption ionization, or electrospray ionization (ESI). A brief description of each of these sequencing methods follows, with a:

I. The Edman Degradation Process

The Edman degradation process, first described by P. Edman in 1957, is the basis for modem chemical peptide sequencing. The Edman degradation process operates by removing and identifying each amino acid from the N-terminal end of a protein, thereby allowing a practitioner to identify the composition and sequence of a particular protein. P. Edman, ACTA. CHEM SCAND. 10,761 (1957). More specifically, three reactions are used in the Edman degradation process to remove each N-terminal amino acid: (1) coupling, (2) cleavage, and (3) conversion.

The first reaction, often referred to as coupling, modifies the N-terminal amino acid by adding phenylisothiocyanate (“PITC”.) to the amino group, typically in a base-catalyzed reaction. The result of coupling is a phenylthiocarbamyl (“PTC”) protein with the PTC-coupled amino acid occurring at the N-terminal end of the protein. This PTC-coupled amino acid can then be subjected to the second reaction, cleavage, to remove the PTC-coupled amino acid from the protein. The cleavage reaction is typically performed by treating the PTC protein with an anhydrous acid, thereby allowing the sulfur from the PTC group to react with the first carbonyl carbon in the protein chain. As such, this cyclization reaction results in the removal of the first amino acid as an 2-anilino-5(4)-thiozolinone (“ATZ”) derivative, thereby exposing the next N-terminal amino acid on the protein. At this point the, cleaved amino acid, as an ATZ derivative, can be extracted from the residual polypeptide. The cleaved amino acid is then subjected to the third reaction, conversion, wherein the ATZ derivative is converted to a phenylthiohydantoin (“PTH”) amino acid (the “converted amino acid”) by exposing the ATZ derivative to heat and an aqueous, methanolic, or anhydrous acid. The PTH amino acid is more stable and allows for analyzing and identification of the amino acid.

Identification of the PTH amino acid derivative may be performed by either using fluorescent reagents that attach to the cleaved PTH amino acid derivative, or by using fluorescent reagents in the earlier steps of the Edman process to cause a fluorescent-coupled PTH amino acid derivative. However, such reactions are slow, and may result in low percentages of fluorescent coupled amino acid derivatives due to the fact that fluorescent reagents tend to have unfavorable electron configuration. As a result, other methods of identification, including the use of gas liquid chromatography such as high pressure liquid chromatography (“HPLC”), surface phase microextraction chromatography, or mass spectrometry may be used to identify the PTH amino acid derivative.

According to the Edman degradation process, the process of coupling, cleaving, and then converting and identifying the amino acid from the remaining polypeptide is then continued in an iterative fashion until each of the amino acids comprising the original protein have been removed from the N-terminal end and identified.

II. Thioacylation Protein Sequencing

As an improvement on the Edman degradation process, thioacylation allows the use of relatively mild conditions and faster reactions than the original Edman degradation. Typical thioacylation sequencing involves three steps, similar to the Edman degradation, but the coupling step results in attaching the N-terminal amino acid to an insoluble support, allowing for solid phase chemistry to be utilized.

A more complete discussion of thioacylation degradation can be found in U.S. Pat. No. 5,246,865 to Stolowitz et al. (the “Stolowitz Patent”), which is incorporated by reference herein. The Stolowitz Patent indicates that the most of the proposed compounds used for thioacylation have a lower reactivity than the PITC utilized in the Edman degradation process. The Stolowitz Patent discloses the use of more generally available reagents that display better reactivity than the previous thioacylating compounds and allow for better deposition of the cleaved amino acid complexes on a hydrophobic membrane. Thus, the method disclosed in the Stolowitz Patent allows for a more sensitive sequencing system due to the increased reactivity and better retention on a hydrophobic film layer. Further, gas chromatography, mass spectrometry, or chemical ionization mass spectrometry can be used to identify each amino acid complex that is removed from the polypeptide or protein in each iteration of the degradation reaction by the thioacylation protein sequencing process. However, the method disclosed in the Stolowitz Patent utilizes reactants that may modify the side chains of amino acids, making proper sequencing difficult.

III. Mass Spectrometry

Protein sequencing through the use of mass spectrometry is used in many chemical identification applications by measuring the ratio between the mass and charge of a sample. While it is possible to sequence larger polypeptides using mass spectrometry, substantial computing power is required to perform such an analysis. Further, mass spectrometry protein sequencing cannot accurately identify large proteins without modification of the proteins, either through ionization of the proteins (usually performed through electrospray ionization), or chemical or enzymatic digestion of the proteins into smaller polypeptides, each of which may cause the transformation of certain amino acids.

Variations of protein sequencing using mass spectrometry include ladder sequencing. Ladder sequencing utilizes mass spectrometry to compare the resultant peptides that are given off after sequential digesting of proteins. The digestion process may be performed using enzymatic techniques that cleave a protein into multiple polypeptides, or as a modified Edman chemical degradation.

Several methods for performing ladder sequencing may be used, including the use of exopeptidases to cleave off terminal amino acids or dipeptides. This technique has limited application due to the variability of reactivity with respect to the target protein. Alternatively, PITC with a low percentage of phenylisocyanate (“PIC”) has been used to generate several peptide fragments that can be compared to statistically determine the sequence of the protein in a mixture. This PITC/PIC method has the disadvantage of resulting in a substantial loss of peptides during washing cycles, and reducing the effectiveness of ionization of the products, which can significantly alter the effectiveness of sequencing when small protein sample sizes are utilized.

As will be appreciated, the multiple approaches taken to protein sequencing have been made in an attempt to produce a protein sequencing system that: can be used with high sensitivity so that small samples can be accurately sequenced, can be used on a broad range of proteins without selectivity issues; and which allows a higher throughput of samples to allow protein sequencing to be used on a larger and more efficient scale. However, the several approaches noted above do not allow large sample sizes to be run in short time periods due to the multiple iterations of cycling required under the Edman process and its related methods, and due to the focus on obtaining high sensitivity in sequencing results. Conversely a reliable, high throughput system would be greatly appreciated in the art to allow qualitative identification of protein or peptide sequences.

IV. Automated Sequencing

As will be appreciated from the above discussion of protein sequencing, the processes involved in any degradation or enzymatic digestion sequencing is repetitive and can be time consuming-particularly when small sample sizes are involved and care must be taken not to lose a substantial amount of the sample during processing. As such, automated chemical systems have been developed to perform such tasks. For example, U.S. Pat. No. 6,813,568 to Powell et al. (the “Powell Patent”), incorporated by reference herein, claims that chemical analysis results in more easily interpreted sequences than mass spectrometry, but that chemical analysis is “at least ten to twenty times less sensitive than most mass [spectrometry] analyzers.” Col. 1, Ins. 50-54. As such, the Powell Patent discloses a microfluidics-based automated protein sequencing system that includes several rotary selector valves and switching valves attached to a processor to direct delivery of reagents and high pressure reactants to use with high pressure or gas chromatography, a cleavage reactor vessel for each protein being analyzed, a conversion reactor for each protein being analyzed, and a restraining means for restraining unprocessed polymer in a reaction vessel.

As such, the automated apparatus disclosed in the Powell Patent includes several valves that must operate under high pressure, and includes a conversion reactor for each protein analyzed. Because conversion can be a rate limiting step in protein sequencing, and the additional conversion vessels required for each sample necessarily adds to the mass of a protein sequencer, a system and apparatus that would allow for reduced cost in manufacturing and increased throughput of samples would be greatly appreciated.

Further, a system and method that would allow for greater flexibility in the type of processing and detection used in protein sequencing would be greatly appreciated. Finally, a system and method that allows for modular increases in the number of samples that can be processed at any given time while still retaining reliability would be greatly appreciated.

### BRIEF DESCRIPTION OF THE DRAWINGS

FIG. 1 illustrates the sectioned front view of a protein sequencing system according to one embodiment of the present application FIG. 2 illustrates a perspective view of a manifold reservoir assembly that is comprised in the protein sequencing system displayed in FIG. 1.

FIG. 3 is a perspective view of the protein sequencing system of FIG. 1, displaying the removable nature of a reaction plate.

FIG. 4 illustrates the sectioned view at inlet level (A-A′) of a protein sequencing system according to another embodiment of the present application, showing the location of inlet ports.

FIG. 5 illustrates a sectioned view at outlet level (B-B′) of the protein sequencing system of FIG. 4.

FIG. 6 illustrates a perspective view of a fluid selector mechanism of the protein sequencing system of FIG. 4.

FIG. 7 illustrates a perspective view of a fluid selector mechanism of the protein sequencing system in accordance with an embodiment wherein the inlet channels are located at multiple horizontal levels.

FIG. 8 illustrates the schematic diagram of the protein sequencing system in accordance with an embodiment wherein the bioreactor device comprises multiple reactor chambers.

FIG. 9 illustrates a schematic diagram of the protein sequencing system in accordance with the present application, indicating the relationship between a controller or processor and the protein sequencing system.

### SUMMARY

### DETAILED DESCRIPTION

A. Overview

The present application relates to a system and apparatus for performing high throughput protein sequencing with reliable identification of proteins or polypeptides. Contrary to prior sequencing methods that require iterative sequencing of each of the N-terminal amino acids and subsequently identify each amino acid cleaved from the protein or polypeptide to reconstruct a sequence, the present application relates to a system of identifying proteins or polypeptides from an organism or other protein source utilizing a minimal number of cleavage cycles and with no requirement for conversion of the cleaved samples to identify the sample protein or polypeptide.

One embodiment of the present application relates to utilizing a known DNA, RNA, or protein library to act as a known set of sequences against which unknown proteins may be compared for identification. In particular, the identification of proteins or polypeptides from a particular organism or group of organisms (such as populations, subspecies, species, genera, etc.) is used to narrow the universe of potential proteins that are being tested to a discrete protein population. By way of nonlimiting example, a DNA sample, RNA sample, or array of proteins from the organism or groups of organisms may be used to form or extrapolate a library of protein sequences of the relevant protein population for later identification of an unknown protein sample or samples. It will be appreciated that protein population libraries can be identified by using previous methods of DNA or RNA sequencing, mass spectroscopy, or in depth protein sequencing. Because the libraries of genomes for various organisms are now available from many different sources, a protein population for an organism or group of organisms may be readily available, and relevant proteins may be identified without any sequencing performed prior to testing unknown samples.

In one embodiment, a system for identifying proteins comprises the cleavage of about five or fewer N-terminal or C-terminal amino acids from an unknown protein or amino acid using chemistries used in the ladder process, Edman process, thioacylation process, or other known processes. For example, five or fewer coupling and cleavage reactions may be cyclically performed to remove the first five or fewer amino acids from the unknown protein. After each cycle, the cleaved amino acid may be washed off from the reaction vessel and identified. The identification of the first five or fewer amino acids is then recorded as a partial sequence, and that partial sequence is compared to the protein sequence library previously discussed.

It will be appreciated that several proteins from the protein population represented in the protein sequence library may have identical amino acid sequences to that of the unknown sample. This is one reason why the Edman process and other processes previously used require sequencing by identifying each amino acid in an unknown sample to identify the polypeptide or protein. However, according to one aspect of the present application, the molecular weight of each unknown sample is also taken and compared against the molecular weight of the population proteins identified by comparing the first five or fewer amino acids of the unknown sample with the protein sequence library. In this manner, when both the first five or fewer amino acids of an unknown sample and its molecular weight are compared to the first five amino acids and molecular weight of the protein population accumulated for the protein sequence library, nearly all unknown samples from a particular organism can be identified simply by comparing the discovered sequence and molecular weight. As such, identification through limited sequencing can be accomplished without exhaustive and iterative sequencing. In the event that the first five or fewer amino acids and molecular weight cannot positively identify the unknown sample as a single protein or peptide from the identified protein population, additional sequencing may be performed on the unknown sample. In the event that several proteins with identical sequences of the first five amino acids are identified in a protein sequencing library, the first 10 or fewer, or the first 20 or fewer amino acids for each sample could be taken. However, a significant reduction in time taken to identify the samples would be appreciated even if only half of the unknown samples were immediately identifiable through the comparison method, or if.

It will be appreciated that alternative embodiments in which the first 6 or fewer amino acids from the N-terminal or C-terminal end are identified along with the molecular weight of the unidentified protein may be compared to the protein population to identify the unknown protein. Alternatively, embodiments in which the first 10 or fewer amino acids from the N-terminal or C-terminal end are identified along with the molecular weight of the unidentified protein are compared to the protein population to identify the unknown protein. Alternatively, embodiments in which the first 20 or fewer amino acids from the N-terminal or C-terminal end are identified along with the molecular weight of the unidentified protein are compared to the protein population to identify the unknown protein. Alternatively, embodiments in which the first 30 or fewer amino acids from the N-terminal or C-terminal end are identified along with the molecular weight of the unidentified protein are compared to the protein population to identify the unknown protein.

In an alternative embodiment, a protein population or protein sequence library may not be created prior to the sequencing of unknown samples. For example, one or more samples may be processed in a manner that identifies the first 5 or fewer amino acids in sequence, the first 6 or fewer amino acids in sequence, the first 10 or fewer amino acids in sequence, or the first 20 or fewer amino acids in sequence, along with the molecular weight of the one or more unknown protein samples. Once the initial amino acid sequence is identified, a mapped genome may be analyzed to identify all potential proteins that may be produced by the organism in question, or an RNA, DNA, or known protein samples may be probed to identify a protein population that has an identical initial sequence by, for example, a blast search.

According to yet another embodiment of the present application, a short series of ladder sequencing may be utilized to cleave an unknown sample that has been bonded or attached to a solid surface (such as a membrane) into several different sized polypeptide fragments. Once the free fragments are washed, the solid surface may be subjected to mass spectrometry to identify the sequence of a certain number of amino acids within the protein. The location of these identified amino acids, along with the molecular weight of the sample, can then be compared against a previously generated protein sequence library as discussed above, or may be used to probe a genome, RNA, or DNA as previously discussed to identify an unknown protein sample.

It will be appreciated that each of the above embodiments can be performed by obtaining a relatively pure protein sample from a mixed protein sample by utilizing a 2D separation, such as gel electrophorisis or chromatography, to separate out the various proteins in an unknown sample into its individual protein samples. Alternatively, a 1D separation may be performed, with the mass differences of the proteins in a mixed sample may be utilized to identify the multiple proteins in a mixed sample, although such a mixture will complicate analysis of the sample.

### EXAMPLE

An exemplary embodiment of one aspect of the present application would involve the use of an unknown mixed protein sample. The unknown mixed protein sample is subjected to a 2D separation, and a purified protein sample is obtained by pulling out one of the samples from the 2D separation—which should hold several molecules of a particular unknown protein. The sample is then adhered to a membrane attached to a reaction vessel and run through an automated system as described below. Reagents are selected to perform a ladder process sequencing by utilizing the PITC/PIC reagents discussed above in a manner to obtain the sequence of the first 6 N-terminal amino acids. After washing the reagents and optionally saving the eluted cleaved peptides and amino acids from the reactor vessel, the remaining fragments still attached to the film are subjected to mass spectrometry to determine the sequence of the first 6 N-terminal amino acids and the molecular weight of the fragments, from which the molecular weight of the entire sample can be derived, if necessary.

In this example, the amino acid sequence for the first 6 amino acids is GDPGGV. A search of a known protein database for the 6 amino acid sequence, in this instance, the database maintained for proteins at the National Center for Biotechnology Information, is searched for the GDPGGV sequence. A total of 46 possible proteins are identified when a search of this 6 amino acid sequence is performed. Additionally, the 46 possible proteins identified include proteins from several different organisms. This list can be substantially reduced by removing all but the known organism from which the sample was taken, if known. Additionally, the number in the protein sequence where the GDPGGV sequence is found is identified in the database, so it can be determined whether the unknown protein was later phosphorylated or otherwise changed from its original state in the organism from which it came.

In the event that no such results are present for a given sequence, a DNA or RNA probe corresponding to the amino acid sequence can be created to identify the sequence in the organism's DNA that codes for the protein, thereby allowing the identification of the protein.

B. Automated System Embodiments

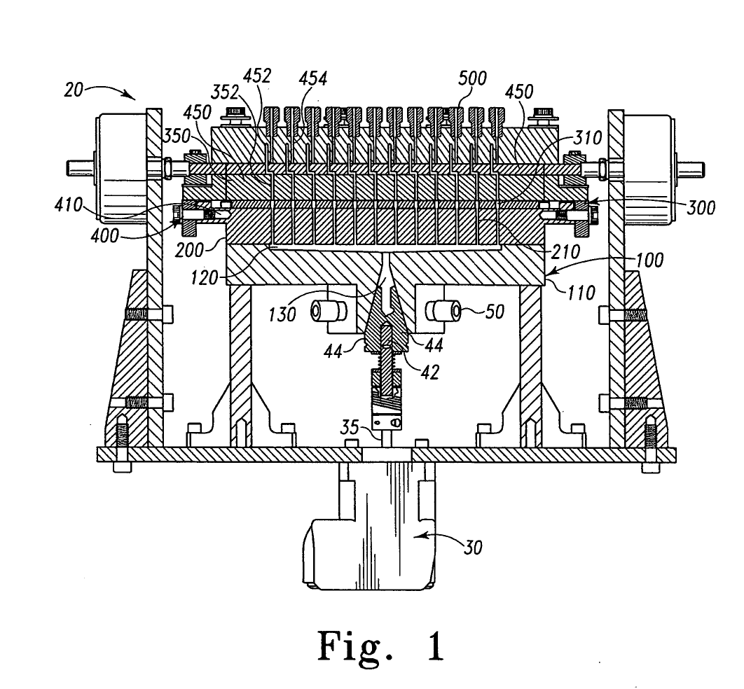

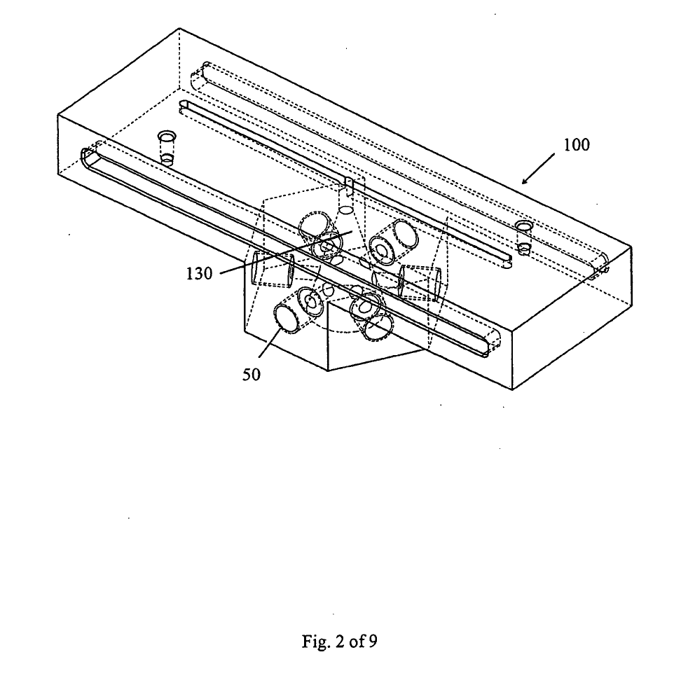

Turning now to FIG. 1, an automated system for identifying and or sequencing proteins is discussed. According to one embodiment, a protein sequencing system 20 comprises a motor 30 attached to a rotatable valve 40 by way of a shaft 35. Rotatable valve 40 comprises an inner selector portion 42 connected to shaft 35 and operable to be rotated such that its one or more outlet (not shown) aligns with one or more fluid inlet ports 50. Motor 30 is optionally a stepper motor and may optionally be in communication with a processor or controller that is operable to direct the motor to align the one or more outlets with an appropriate fluid inlet port 50 to allow fluid to flow into inlet channel 130 of manifold reservoir assembly 100. Fluid inlet port may optionally be connected to a pump, for example, a syringe pump. Protein sequencing system 20 further comprises fluid inlet ports 50 in connection with injectors 60 (not shown) that are either directly connected to inlet ports 50 or via tubing or other connectors. Once a fluid flows into inlet channel 130, the fluid flows through manifold branches 210 of manifold branch assembly 200.

Protein sequencing system 20 further comprises a reaction plate 300 having multiple reaction vessels 310. Reaction vessels 310 are sized and shaped to allow deposition of a sample onto a membrane (not shown) attached to reaction vessel 310 or onto the edges of reaction vessel 310. Further, reaction vessels 310 may comprise several holes drilled through reaction plate 300 such that each reaction vessel 310 corresponds with one of the manifold branches 210 of manifold branch assembly 200 sealably attached to its bottom end. On the top end of reaction plate 300 is sealably attached to an exit channel assembly 350 comprising several exit channels 352 corresponding to each reaction vessel.

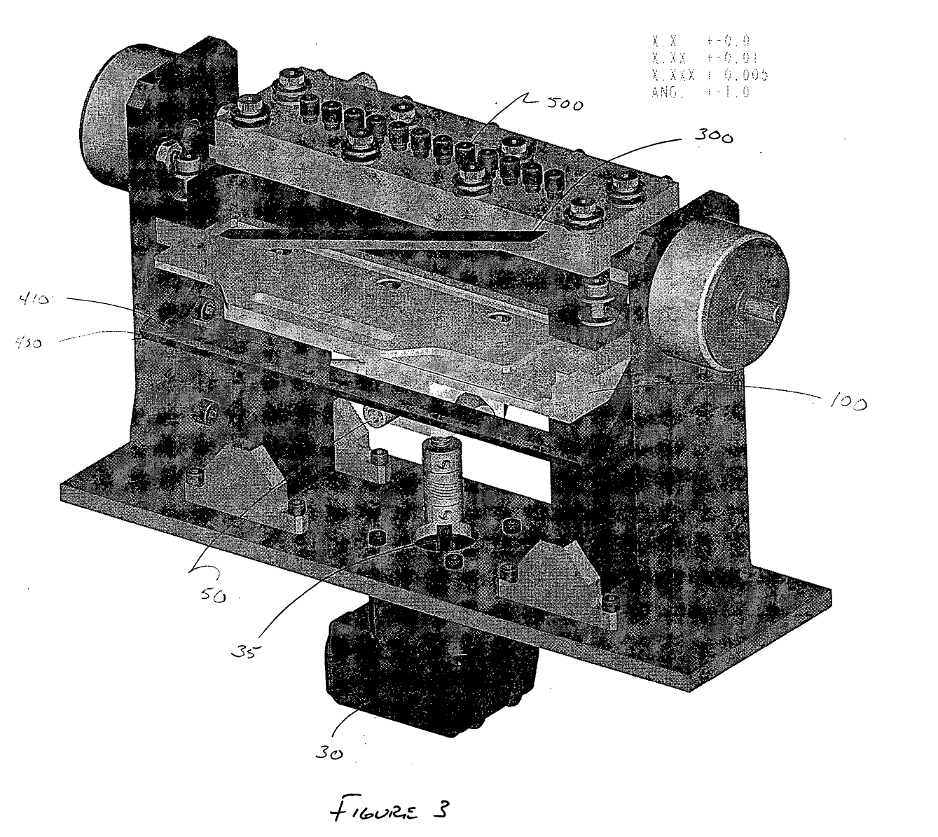

As shown in FIGS. 1 and 3, reaction plate 300 is optionally a removable plate that is releasably clamped between manifold branch assembly 200 and exit channel assembly 350 by a clamp mechanism 400 having an optional cam clamp bar 410. In this manner, additional reaction plates 300 can be sealably engaged with manifold branch assembly 200 and exit channel assembly 350 when clamp mechanism 400 is effected. Conversely, when clamp mechanism 400 is disengaged, as shown in FIG. 3, reaction plate 300 can be removed and replaced with another reaction plate 300.

According to one embodiment, each exit channel 352 has a selection valve 451 placed to allow diversion of any fluids flowing from the reaction vessel 310 to be diverted either to a waste pathway 452 or to a collection port 500. As shown in FIG. 1, the selection valve 451 comprises a slider valve assembly 450 that allows a user to urge the slider valve assembly 450 to a first position in which a waste pathway 452 is aligned with the exit channel, causing any fluid passing through waste pathway 452 to be ejected as waste. Alternately, slider valve assembly 450 may be urged to a second position in which a collection pathway 454 is aligned with the exit channel 352, allowing any fluid passing through collection pathway 454 to be sent through collection port 500 where the fluid may be collected for storage or further testing.

It will be appreciated that the system described above does not include a conversion chamber as is typically dictated by protein sequencing processes. While conversion of any cleaved amino acid can be performed after collection in this system, such conversion is not required, thereby allowing substantially higher throughput than previous systems. In one embodiment, if the cleaved amino acid product is collected, the product is optionally sent through a mass spectrometer for identification of the cleaved amino acid. Alternatively, if a ladder process is used to identify key amino acids within the unknown sample, the cleaved peptides may optionally be channeled through waste pathway 452, with the remaining peptides bonded to a solid surface in the reaction vessel being collected and used to establish the sequence of the unknown protein.

C. Alternate Embodiments.

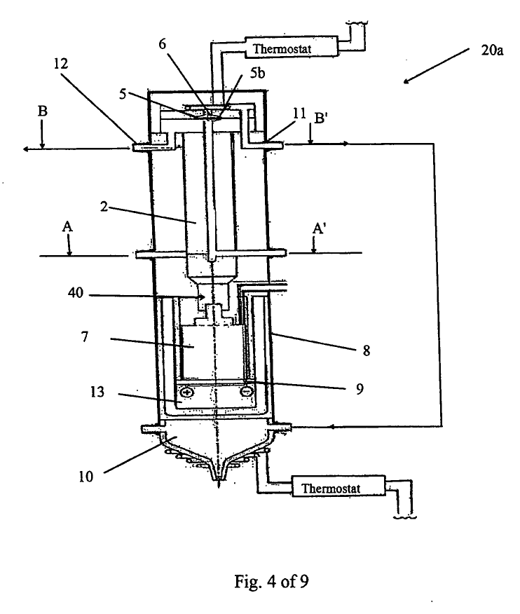

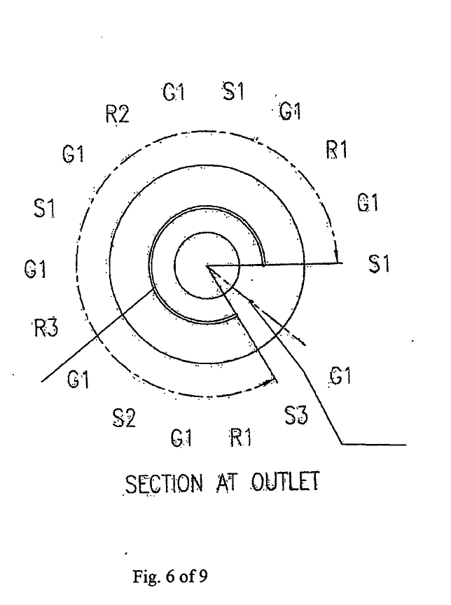

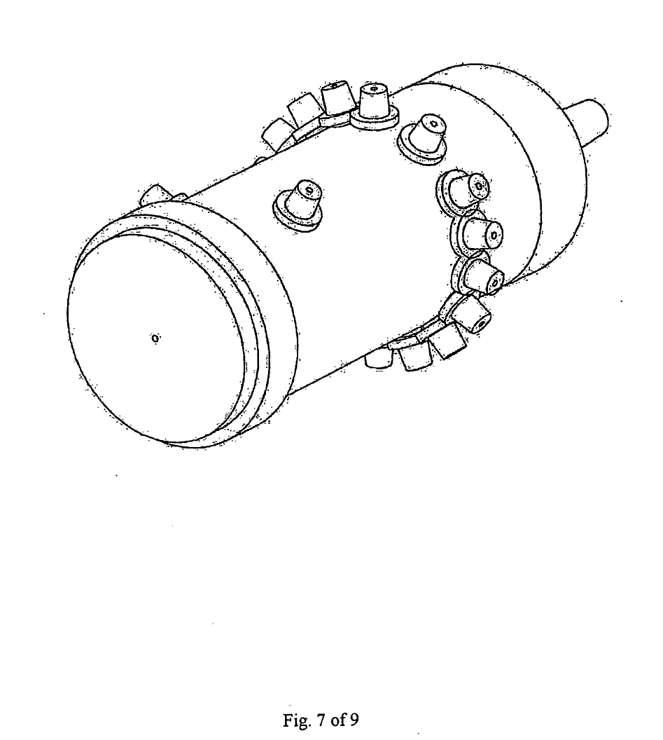

Yet another embodiment according to the present application is shown in FIGS. 4-7. According to this embodiment, a protein sequencing system 20a comprises a rotatable valve 40 comprising an outer stationary pipe 1 and one or more inner rotatable pipes 2. The outer stationary pipe 1 acts as an enclosure to the one or more inner rotatable pipes 2 and comprises multiple fluid inlet ports separated from each other circumferentially and/or longitudinally along an outer circumference (not shown). The inner most rotatable pipe comprises an axial manifold channel 3 in fluid communication with a circumferential manifold channel. The inner pipe(s) 2 are coupled to a rotating mechanism 7 at a first end. A reaction chamber 5 is in fluid flow communication with the axial manifold channel 3 of innermost inner rotatable pipe 2 to allow outer stationary pipe 1 and inner rotatable pipe 2 to act as a rotary valve and enable a supply of a fluid to reaction chamber 5 through the axial manifold channel 3. A product outlet port 11 is further provided in fluid flow communication with reaction chamber 5 for withdrawing any product formed in reaction chamber 5.

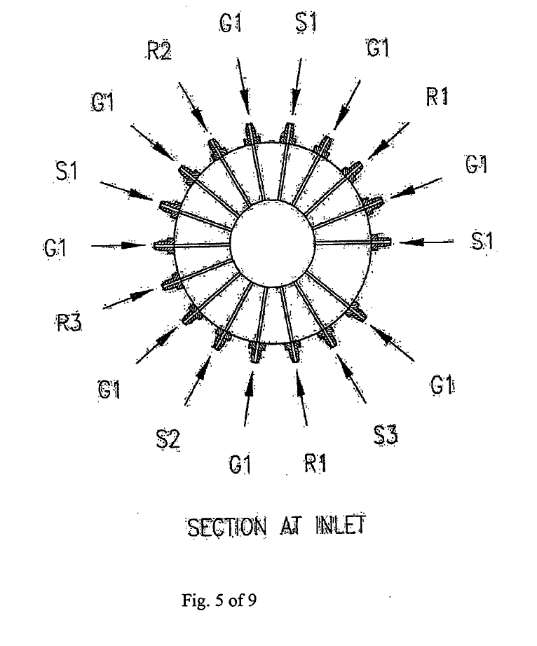

With reference to FIGS. 4 and 5, protein sequencing system 20a comprises housing 8 enclosing two or more substantially concentric pipes, an outer stationary pipe 1 and one or more inner rotatable pipes 2. The outer stationary pipe 1 comprises multiple circumferential manifold channels connected with multiple fluid inlet ports as shown in FIG. 5 (S1, S2, S3, . . . , R1, R2, . . . , G1, G2, . . . ) separated from each other circumferentially. Innermost inner rotatable pipe 2 comprises axial manifold channel 3 in fluid flow communication with a circumferential manifold channel. The inner pipe(s) 2 are coupled to rotating mechanism 7 at one end. Reaction chamber 5 is in fluid communication with axial manifold channel 3 of the inner most pipe 2. Rotating mechanism 7 is arranged to rotate the inner pipe(s) 2 and operate to place circumferential manifold channel located on the in fluid communication with one or more fluid inlet ports, thereby supplying a fluid to the reaction chamber through axial manifold channel 3. Outer stationary pipe 1 is further provided with an outlet port 11 which is brought in fluid communication with reaction chamber 5 for withdrawing the product thus formed in the reaction chamber 5. Inner movable pipe(s) 2 and outer stationary pipe 1 are constructed of materials inert with respect to the chemicals they transport and have suitable mechanical properties such that, for example, they fit snuggly or tightly without leakage.

Optionally, as shown in FIG. 4, the protein sequencing system 20a is further provided with a waste outlet 12 in fluid flow communication with reaction chamber 5 for withdrawing waste products from reaction chamber 5. Further, it will be appreciated that reaction chamber 5 is optionally formed as a two part construction to locate at least one substrate therein. According to another optional embodiment, reactor chamber 5 is further provided with a heating device 13.

It will be appreciated that several optional features may be present. For example, supply terminals may be connected to the housing for supplying power to an electrical motor and/or a heating device located inside the reactor chamber. Further, a controlling unit is optionally located inside a housing for controlling the operation of the electrical motor. In another embodiment, a communication device is optionally located inside the housing for communicating with a remotely located controlling unit thereby enabling controlling the operation of the electrical motor, and the communication device is a wireless communication device.

In yet another embodiment of the present invention, the controlling unit is programmed by a processor or a controller to determine the sequence in which the circumferential manifold channel located on the inner most pipe is brought in fluid flow communication with one of the fluid inlet ports/channels of the outer pipe and the time period for which the circumferential manifold channel located on the inner most pipe is brought in fluid flow communication with one of the fluid inlet ports/channels of the outer pipe.

In addition, according to one embodiment shown in FIG. 4, outer stationary pipe 1 is optionally provided with a waste outlet 12 in fluid flow communication with reaction chamber 5 for withdrawing waste products from reaction chamber 5. Optionally, reaction chamber 5 is formed as a two part construction, separated by a porous filtering medium to locate a substrate on a solid support 6, for example a Zytex membrane with protein(s) deposited thereon. A bottom portion of the reaction chamber 5a is fixed to inner pipe(s) 2 at top. The bottom portion of reaction chamber 5a comprises a means for receiving the substrate having the protein to be identified and a channel which is aligned with the axial manifold channel 3 of inner tube 2. A top portion of the reaction chamber 5b is fitted on bottom portion 5a, further comprising a channel in fluid flow communication with axial manifold channel 3.

Optionally, the controlling unit is programmed by the user to determine the sequence in which the circumferential manifold channel located on the inner most pipe is brought in fluid flow communication with one of the fluid inlet ports/channels of the outer pipe and the time period for which the circumferential manifold channel located on the inner most pipe is brought in fluid flow communication with one of the fluid inlet ports/channels of the outer pipe. Further, the temperature of the reactor and/or the product chamber(s) can be also so controlled by providing power to the heaters provided for the reactor and/or product chamber(s) for variable periods of time.

D. Slider Valve

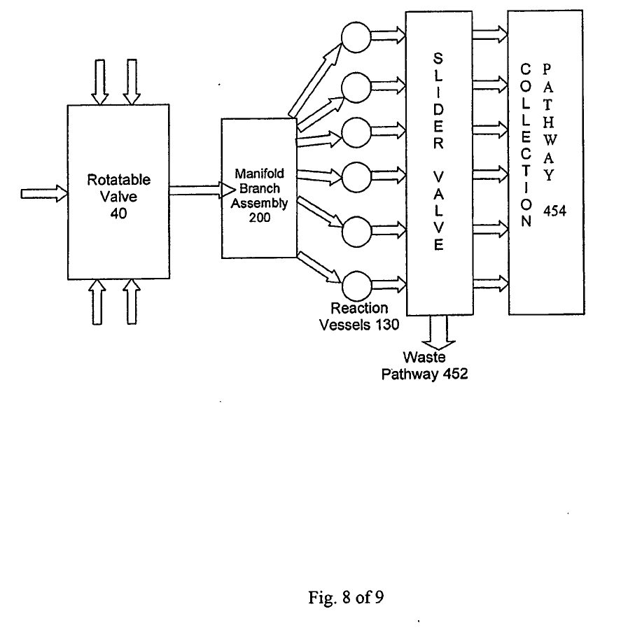

Turning now to FIG. 8, a flow diagram displays a general flow pathway indicating the system of addressing multiple reaction vessels 130 from a single rotatable valve 40. As can be seen, rotatable valve 40 allows selection of a reagent from multiple fluid inlet ports 50, sending the selected reagent into manifold reservoir assembly 100 (FIG. 1) and sent through manifold branch assembly 200 to each of the multiple reaction vessels 130, where reaction takes place between the protein sample and the selected reagent. Thereafter, slider valve assembly 450 is utilized to select either the waste pathway 452, in which the reagent and any free products are disposed, or through collection pathway 454, in which the reagent and any product are collected separately for further processing or held as a sample.

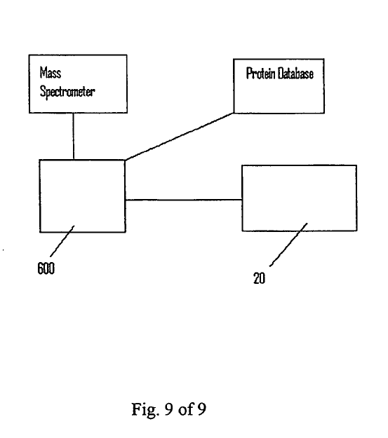

Turning now to FIG. 9, a diagram showing a controller or processor connected to protein sequencing system 20. As will be appreciated controller or processor 600 may comprise a computer processor operable to control the motor 30 to allow control of the reagents sent through rotatable valve 40 through the device. Further, control of any pumps, such as syringe pumps or other pumping devices used to deliver reagents to fluid inlet ports may be controlled by controller or processor 600. It will be appreciated that controller or processor 600 may further comprise a database or access to a database of protein sequences to compare any results from sequencing with the database of protein sequences, thereby identifying a particular protein with only a partial sequence match.

Although the embodiments above have been described in detail with reference to preferred embodiments, variations and modifications exist within the scope and spirit of the invention as described and defined in the following claims.

1. A protein sequencing system comprising:
a. a protein sequence library from an organism or group of organisms from which a plurality of unknown protein samples are taken;
b. a protein sequencer having a plurality of reactor vessels in fluid communication with at least one fluid inlet port and wherein each reactor vessel is operable to retain one of the plurality of unknown protein samples;
c. at least one cleavage reactant operable to cleave one or more amino acids from the unknown protein samples and result in a remaining polypeptide or dipeptide;
d. at least one exit pathway in fluid connection with the reactor vessel and operable to select between disposing of any cleaved amino acids or collecting any cleaved amino acids; and
e. wherein the protein sequencing system is devoid of a conversion chamber.

2. The protein sequencing system of claim 1, wherein each of the plurality of unknown protein samples is bonded to a solid surface located within each reaction vessel.

3. The protein sequencing system of claim 1, wherein the plurality of reactor vessels are contained within a reactor plate that is releasably clamped in fluid connection with the at least one fluid inlet port and the at least one exit pathway.

4. The protein sequencing system of claim 1, further comprising a mass spectrometer operable to analyze the cleaved amino acids or the any remaining polypeptide or dipeptide.

5. The protein sequencing system of claim 4, wherein the cleaved amino acids comprise the first five or fewer N-terminal amino acids of each of the plurality of unknown protein samples.

6. The protein sequencing system of claim 5, wherein the mass spectrometer is further operable to determine the molecular weight of the unknown protein samples.

7. The protein sequencing system of claim 6, further comprising a processor, the processor housing the protein sequence library, the processor further operable to compare the first five or fewer N-terminal amino acids of the unknown protein samples to the first five or fewer N-terminal amino acids of proteins within the protein sequence library, and wherein the processor is further operable to compare the molecular weight of the unknown protein samples with the molecular weight of the proteins within the protein sequence library.

8. A protein sequencing system comprising:
a. a plurality of fluid inlet ports operable to receive reactants into an inlet channel;
b. a rotary valve in fluid connection with the plurality of fluid inlet ports and the operable to select which, if any, of the reactants are received in the inlet channel from one or more of the plurality of fluid inlet ports;
c. a manifold comprising a plurality of manifold branches in fluid communication with the inlet channel and connecting a plurality of reaction vessels with the fluid inlet port, the reaction vessels operable to receive a protein sample to be sequenced;
d. a plurality of exit channels in fluid connection with the reaction vessels on one end and connected to a valve on the other end, the valve operably connected to a waste pathway and a collection pathway;
e. the protein sequencing system further being devoid of a conversion chamber.

9. The protein sequencing system of claim 8, further comprising a processor operable to maintain a protein sequence library.

10. The protein sequencing system of claim 9, further comprising a mass spectrometer operable to analyze any amino acids cleaved from a protein sample to be sequenced, further operable to analyze any remaining polypeptide or dipeptide from which any amino acids have been cleaved.

11. The protein sequencing system of claim 10, wherein the mass spectrometer is operable to identify the analyzed amino acids wherein the analyzed amino acids comprise the first five or fewer N-terminal amino acids of each of the protein samples.

12. The protein sequencing system of claim 11, wherein the mass spectrometer is further operable to determine the molecular weight of the unknown protein samples.

13. A protein sequencing system comprising:
a. a protein sequence library from an organism or group of organisms from which a plurality of unknown protein samples are taken;
b. a protein sequencer having a plurality of reactor vessels in fluid communication with at least one fluid inlet port and wherein each reactor vessel is operable to retain one of the plurality of unknown protein samples;
c. at least one cleavage reactant operable to cleave one or more amino acids from the unknown protein samples and result in a remaining polypeptide or dipeptide;
d. at least one exit pathway in fluid connection with the reactor vessel and operable to select between disposing of any cleaved amino acids or collecting any cleaved amino acids; and
e. wherein each of the plurality of unknown protein samples is bonded to a solid surface located within each reaction vessel.

14. The protein sequencing system of claim 13, wherein the protein sequence library is selected after identifying the first five or fewer amino acids comprising at least one of the unknown protein samples.

15. The protein sequencing system of claim 13, wherein the protein sequence library is derived from a genome of the organism or group of organisms.

16. The protein sequencing system of claim 15, wherein the organism is Homo sapiens.
